(19) United States
(12) Patent Application Publication
(10) Pub. No.: US 2025/0389210 A1
(43) Pub. Date: Dec. 25, 2025

(54) HYBRID FIXED-OPEN LOW TEMPERATURE THERMAL RESERVOIR FOR LOW-GRADE HEAT FOR A HEAT PUMP CYCLE

(71) Applicant: Supercritical Storage Company Inc., Lewes, DE (US)

(72) Inventor: Jason A. Mallinak, Akron, OH (US)

(73) Assignee: Supercritical Storage Company Inc., Lewes, DE (US)

(21) Appl. No.: 19/236,384

(22) Filed: Jun. 12, 2025

Related U.S. Application Data
(60) Provisional application No. 63/661,809, filed on Jun. 19, 2024.

(51) Int. Cl. F01K 3/02; F01K 27/00

(52) U.S. Cl. CPC F01K 3/02; F01K 27/00; F05D 2260/205

(57) ABSTRACT

A hybrid low temperature thermal reservoir is for use in a Pumped Thermal Energy Storage (“PTES”) system. The hybrid low temperature thermal reservoir includes at least one fixed-volume, low temperature, thermal reservoir and an open-volume, low temperature, thermal reservoir. The hybrid low temperature thermal reservoir thereby seeks to minimize the weaknesses of both fixed-system and open-system low temperature reservoirs while leveraging their advantages.

### CROSS-REFERENCE TO RELATED APPLICATIONS

The priority, and earlier effective filing date, of U.S. Application Ser. No. 63/661,809, filed Jun. 19, 2024, is hereby claimed for all purposes, including the purpose of priority. U.S. Application Ser. No. 63/661,809 is hereby incorporated by reference as if expressly set forth verbatim herein.

### STATEMENT REGARDING FEDERALLY SPONSORED RESEARCH OR DEVELOPMENT

Not applicable.

### TECHNICAL FIELD

The present disclosure pertains to a Pumped Thermal Energy Storage (“PTES”) system, or heat pump and heat engine, and, more particularly, a PTES system including a hybrid fixed-open low temperature thermal reservoir.

### BACKGROUND

This section introduces information from the art that may be related to or provide context for some aspects of the technique described herein and/or claimed below. This information is background facilitating a better understanding of that which is disclosed herein. This is a discussion of “related” art. That such art is related in no way implies that it is also “prior” art. The related art may or may not be prior art. The discussion is to be read in this light, and not as admissions of prior art.

Pumped Thermal Energy Storage (“PTES”) systems generally operate in at least a charging cycle and a generating cycle. PTES requires a low-temperature thermal resource to supply heat to the heat pump during a charging cycle. Typically, the same thermal resource is used to reject heat by the heat engine in the generating cycle. A low-temperature heat exchanger (“LTX”) exchanges heat between the closed-loop PTES cycle and the low-temperature thermal reservoir (“LTR”), which stores the thermal resource.

The figure of merit for a heat pump is coefficient of performance (COP), defined as the ratio of energy product (high-temperature heat, Qₕ) to energy cost (net work, W). The figure of merit for a heat engine is thermal efficiency (η), defined as the ratio of energy product (net work, W) to energy cost (high-temperature heat, Qₕ). The combined figure of merit for a PTES system is round-trip efficiency (RTE), defined as the product of COP and η. Based on Carnot principles, COP increases as the temperature ratio between the high-temperature thermal reservoir and low-temperature thermal reservoir (Tₕ/T_{c}) decreases. For a given high-temperature product (Qₕ at Tₕ), performance improves when heat is added at a higher low-temperature source (Q_{c} at T_{c}) and when heat is rejected at a lower low-temperature sink (Q_{c} at T_{c}).

SUMMARY

The present disclosure presents a hybrid low temperature thermal reservoir for use in a Pumped Thermal Energy Storage (“PTES”) system. The hybrid low temperature thermal reservoir includes at least one fixed-volume, low temperature, thermal reservoir and an open-volume, low temperature, thermal reservoir. The hybrid low temperature thermal reservoir thereby seeks to minimize the weaknesses of both closed-system and open-system low temperature reservoirs while leveraging their advantages.

In a first aspect, a hybrid low temperature thermal reservoir for use in a Pumped Thermal Energy Storage (“PTES”) system, comprises an open-volume, low temperature, thermal reservoir, a fixed-volume, low temperature, thermal reservoir, and a low temperature thermal medium. In a generating cycle, the low temperature thermal medium is drawn from one of the fixed-volume, low temperature, thermal reservoir and the open-volume, low temperature, thermal reservoir or a combination thereof and, after receiving rejected heat, is returned to the open-volume, low temperature, thermal reservoir, or the fixed-volume, low temperature, thermal reservoir, or a combination thereof. In a charging cycle, the low temperature thermal medium is drawn from one of the fixed-volume, low temperature, thermal reservoir and the open-volume, low temperature, thermal reservoir and, after giving heat, returns to the open-volume, low temperature, thermal reservoir, or the fixed-volume, low temperature, thermal reservoir, or a combination thereof.

Note that, in the first aspect, there is no “normal” scenario in which the low temperature thermal medium will be returned to both the fixed-volume, low temperature, thermal reservoir and the open-volume, low temperature, thermal reservoir in the charging cycle. In this context, “normal” means any operational scenario that would not be considered as unusual or exceptional.

In a second aspect, a Pumped Thermal Energy Storage (“PTES”) system comprises a high temperature thermal reservoir, a hybrid low temperature thermal reservoir, and a working fluid circuit through which a working fluid circulates. The hybrid low temperature thermal reservoir includes an open-volume, low temperature, thermal reservoir and a fixed-volume, low temperature, thermal reservoir. In a charging cycle, heat is rejected from the working fluid to the high temperature thermal reservoir and received from the hybrid low temperature thermal reservoir to the working fluid. In a generating cycle, heat is received from the high temperature thermal reservoir to the working fluid and heat is rejected from the working fluid to the hybrid low temperature thermal reservoir.

In a third aspect, a method for use in operating a Pumped Thermal Energy Storage (“PTES”) system comprises: operating the PTES system in a charging cycle and in a generating cycle. In the generating cycle, a low temperature thermal medium is drawn from a fixed volume low temperature thermal reservoir, an open-volume, low temperature, thermal reservoir, or a combination thereof, of a hybrid low temperature thermal reservoir and, after receiving rejected heat, returns excess heat to the open-volume, low temperature, thermal reservoir or to the fixed-volume reservoir and non-excess heat to the fixed-volume low temperature thermal reservoir. In the charging cycle, the low temperature thermal medium is drawn from a fixed-volume, low temperature, thermal reservoir of the hybrid low temperature thermal reservoir and, after giving heat, returning the low temperature thermal medium to the open-volume, low temperature, thermal reservoir.

The above presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1A-1C illustrate three operational scenarios of a hybrid fixed-open low temperature thermal reservoir in accordance with one or more embodiments.

FIG. 2 illustrates a PTES system according to one or more examples of the disclosure.

FIG. 3A-FIG. 3B illustrate particular the working fluid circuit of a PTES system in one particular embodiment in a charging cycle and a generating cycle, respectively.

FIG. 4A-FIG. 4B illustrate one particular embodiment for the hybrid low temperature thermal reservoir LTR in a generating cycle and a charging cycle respectively.

FIG. 5 illustrates an embodiment for the hybrid low temperature thermal reservoir in the generating cycle.

FIG. 6 is a block diagram of a control system including a programmed controller such as may be used to control fluid flow of the working fluid in some embodiments.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

In a conventional system, the LTR may be a “closed system” or an “open system”. A closed system may be, for example, an engineered storage tank. Closed systems are also sometimes called “fixed” systems because the mass of the thermal medium they contain is fixed. An open system, as the name implies, is a system whose thermal medium does not have a fixed mass. Open systems frequently are environmental systems and thus characterized as open-volume systems. For example, an open system may be a natural reservoir such as ambient air, a geothermal well, or a body of water like a river, a pond, or a lake.

The benefits of a fixed-volume, closed-system LTR include control over the resource thermodynamic state in both “cold charged” (T_{c,c}) and “cold discharged” (T_{c,h}) conditions as well as thermodynamic benefits of those differentiated states. The LTR in its charged state has lower-grade thermal energy, benefiting the generating cycle; conversely, the LTR in its discharged state has higher-grade thermal energy, benefiting the charging cycle. However, the closed system adds to the equipment and footprint requirements.

Additionally, the fixed-volume, closed-system LTR introduces a constraint on system operation, since the LTR mass and T_{c} temperature range of the two cycles must match. System nonidealities (including turbomachinery inefficiencies, piping pressure drop, and heat loss) require the PTES system to reject more low-grade heat than it adds. So, additional heat rejection occurs elsewhere in the PTES system when a fixed, closed-system LTR is used.

The benefits of an open-system LTR include reduced equipment and footprint requirements as well as fewer constraints on system operation and performance given the independent LTR mass and Tc temperature range of the two cycles. However, the open system fails to take thermodynamic advantage of the differentiated charged and discharged states. Additionally, the open system does not control the resource state, which can introduce challenges for using natural resources (e.g. icing of river water or air streams during the charging cycle).

This disclosure provides an improved LTR that uses a hybrid fixed-volume LTR and open-volume LTR to capture the main strengths and eliminate the main weaknesses of each standalone approach. During the generating cycle, the low temperature medium may be drawn from either the fixed-volume LTR or the open-volume LTR. Then, in the charging cycle, the low temperature medium is drawn from the other one of the fixed-volume LTR or the open-volume LTR that was not drawn from in the generating cycle.

The hybrid fixed-open low temperature thermal reservoir therefore combines concepts from an “open-volume LTR” and a “fixed-volume LTR”. No component of the hybrid system is “closed” in the usual understanding in the art since even the fixed reservoir becomes open to heat and mass transfer. The hybrid system therefore is, overall, an open system in the usual understanding in the art. Accordingly, the hybrid fixed-open low temperature thermal reservoir combines concepts of both a fixed-volume LTR and an open-system LTR. Instead of a fixed-system and an open-system, the hybrid fixed-open low temperature thermal reservoir employs a fixed-volume LTR and an open-volume LTR.

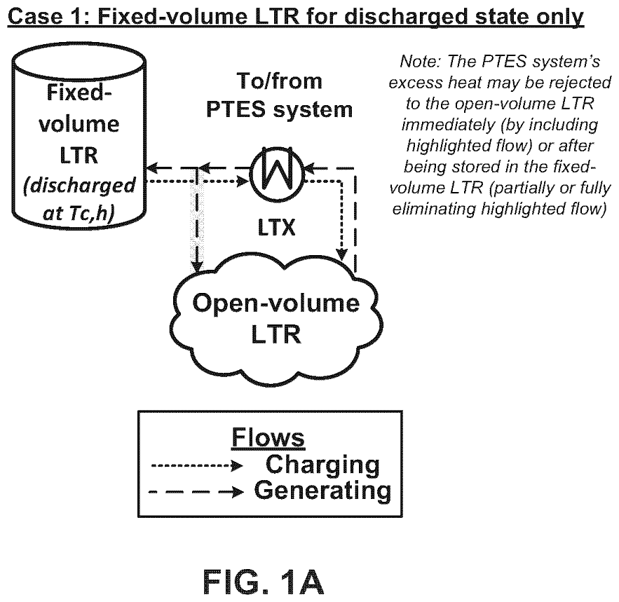

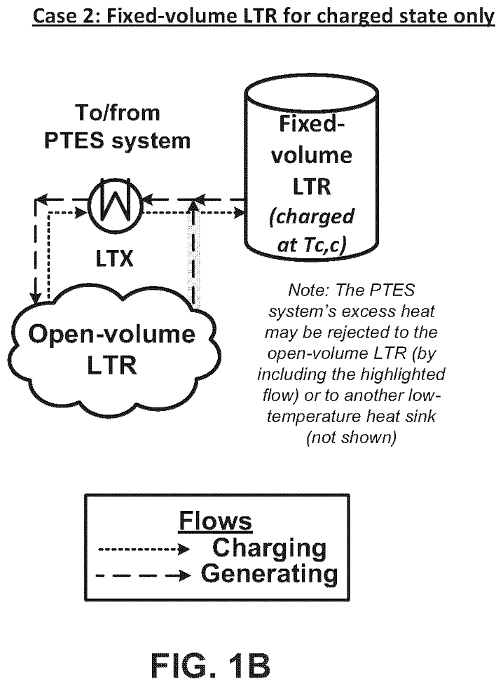

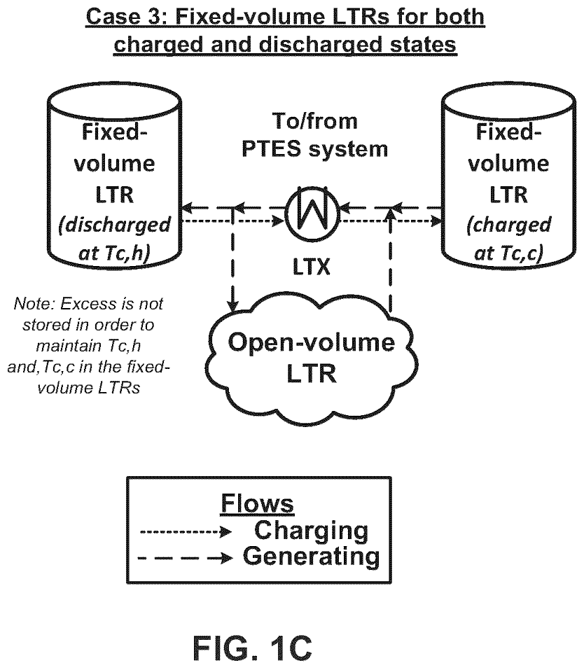

Consider the three scenarios depicted in FIG. 1A-1C. In the hybrid fixed-open low temperature thermal reservoir shown in FIG. 1A, during the generating cycle, the medium is always drawn from the open-volume LTR but never from the fixed-volume LTR. During the charging cycle, the medium is drawn from the fixed-volume LTR but never the open-volume LTR. The converse may also be true as is shown in FIG. 1B. Or, in FIG. 1C, fixed-volume LTRs are drawn from in both cycles. Those in the art having the benefit of this disclosure may envision still further variation.

For another example, in one embodiment, during the generating cycle, the Low temperature thermal medium is drawn from the open-volume LTR. After thermal energy is added to the low temperature medium through the heat engine's heat rejection in the LTX, some or all of the low temperature thermal medium fills the fixed-volume LTR (water tank). The system nonidealities result in the low-temperature heat rejection exceeding the low-temperature heat addition, requiring the excess heat rejected by the generating cycle to be managed either by immediately returning a fraction of the flow to the open-volume LTR or by storing the excess heat in the fixed-volume LTR. During the charging cycle, the low temperature thermal medium is drawn from the fixed-volume LTR. After thermal energy is removed through the heat pump's heat addition in the LTX, the previously-stored low temperature thermal medium returns to the open-volume LTR.

As used herein, the term “excess heat” means heat introduced to the system over and above the heat intentionally added through heat exchange in the heat exchangers—e.g., the low temperature heat exchanger and the high temperature heat exchanger. Excess heat is typically added through system nonidealities. System nonidealities may include, for example and without limitation, turbomachinery inefficiencies, piping pressure drop, heat leak, etc. The term “non-excess heat” means heat other than “excess heat” introduced to the system—i.e., heat intentionally added through heat exchange in the heat exchangers.

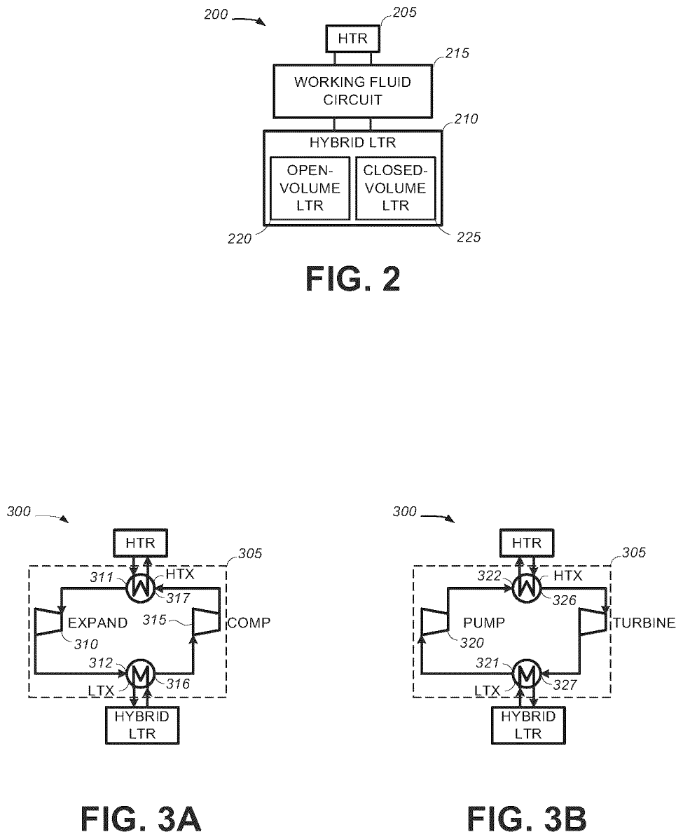

Turning to the drawings, FIG. 2 illustrates a PTES system 200. The PTES system 200 includes a high temperature thermal reservoir 205, a hybrid low temperature thermal reservoir 210, and a working fluid circuit 215. Although not shown in FIG. 2, those in the art having the benefit of this disclosure will appreciate that the working fluid circuit 215 will be configured differently depending on whether the PTES system 200 is operating in a generating cycle or a charging cycle as will be discussed further below. A working fluid (not separately shown) circulates through the working fluid circuit 215. During this circulation, heat is exchanged between the working fluid and the high temperature medium 205 (not separately shown) of the high temperature thermal reservoir and the low temperature medium (not separately shown) of the low temperature thermal reservoir 210.

The hybrid low temperature thermal reservoir 210 includes an open-volume low temperature thermal reservoir 220 and a fixed-volume low temperature thermal reservoir 225. In a charging cycle, heat is rejected from the working fluid to the high temperature thermal reservoir and received from the hybrid low temperature thermal reservoir to the working fluid. In a generating cycle, heat is received from the high temperature thermal reservoir to the working fluid and heat is rejected from the working fluid to the hybrid low temperature thermal reservoir.

The fixed-volume, low temperature thermal reservoir may be, for example, an engineered tank. The open-volume, low temperature thermal reservoir will typically be some type of environmental system. Examples of environmental systems that may be suitable in some embodiments include, but are not limited to, ambient atmosphere, a geothermal well, or a natural body of water. Suitable natural bodies of water may be, for instance, rivers, canals, ponds, and lakes, whether manmade or naturally occurring.

FIG. 3A-FIG. 3B illustrate the working fluid circuit of a PTES system 300 in one particular embodiment in a charging cycle and a generating cycle, respectively. As shown in FIG. 3A, in the charging cycle, heat is added to the working fluid through the low-temperature heat exchanger LTX and rejected from the working fluid through the high-temperature heat exchanger HTX. As shown in FIG. 3B, in the generating cycle, heat is added to the working fluid through the high-temperature heat exchanger HTX and rejected from the working fluid through the low-temperature heat exchanger LTX.

As mentioned above, the configuration of the working fluid circuit 305 depends on whether the PTES system 300 is operating in the charging cycle or in the generating cycle. In the charging cycle of FIG. 3A, an expansion device 310—e.g., an expander-is positioned between an output 311 from the high temperature heat exchanger HTX and an input 312 to low temperature heat exchanger LTX. A compression device 315—e.g., a compressor-is positioned between an output 316 of the low temperature heat exchanger LTX and an input 317 to the high temperature heat exchanger HTX. In the generating cycle of FIG. 3B, a pump 320 is positioned between an output 321 of the low temperature heat exchanger LTX and an input 322 to the high temperature heat exchanger HTX. A turbine 325 is positioned between an output 326 of the high temperature heat exchanger and an input 327 to the low temperature exchanger.

The high temperature thermal reservoir HTR may be a closed system. The high temperature thermal reservoir HTR may then employ any suitable high temperature medium for the particular design being implemented. In the illustrated embodiment, the high temperature thermal reservoir HTR is a closed system and the high temperature medium is water.

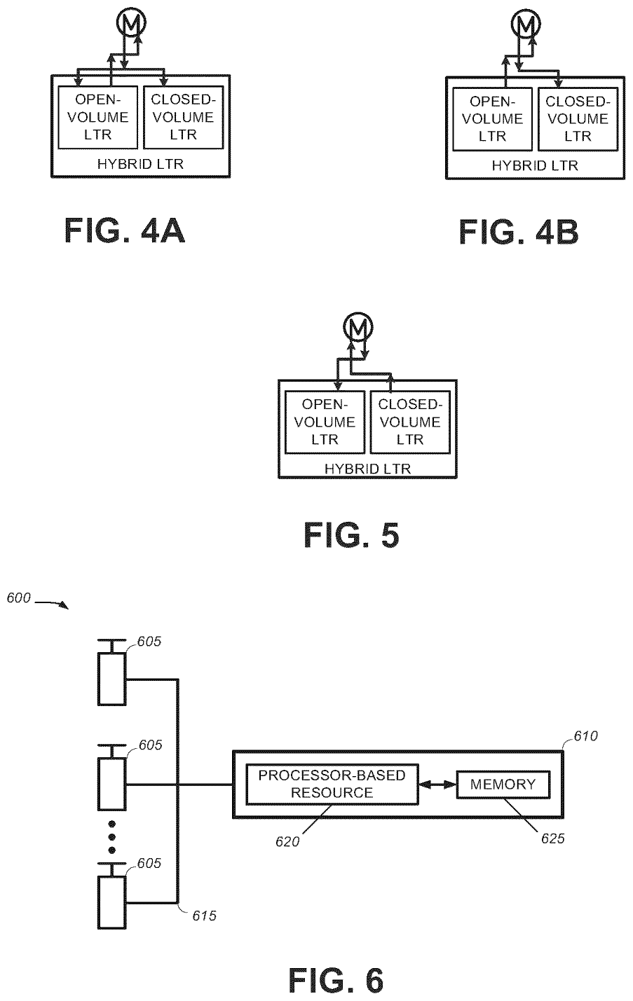

However, as discussed above, the hybrid low temperature thermal reservoir includes both an open volume and a closed volume. FIG. 4A-FIG. 4B illustrate one particular embodiment for the hybrid low temperature thermal reservoir LTR in a generating cycle and a charging cycle respectively. As illustrated in FIG. 4A, in the generating cycle, the low temperature medium is drawn from the open-volume LTR and returned to both the fixed-volume LTR and the open-volume LTR. As shown in FIG. 4B, in the charging cycle, the low temperature medium is drawn from the fixed-volume LTR and returned to the open-volume LTR. This illustrated embodiment disclosed herein uses a water tank as the fixed-volume LTR and a river as the open-volume LTR. Alternative embodiments may implement the two systems in other ways and may use other thermal media.

The subject matter claimed below admits variation in the implementation of the hybrid LTR. For example, FIG. 5 illustrates an embodiment in which, in the generating cycle, the low temperature medium is drawn from the open-volume LTR and returned to the fixed-volume LTR. Those in the art having the benefit of this disclosure may realize still other variations.

As those in the art having the benefit of this disclosure will appreciate, the heat pumps of FIG. 2 and FIG. 3A-FIG. 3B, as well as other embodiments, may also include other thermal reservoirs, other heat exchangers, piping, pumps, valves and other controls not separately shown. For example, the flow of the working fluid through the working fluid circuit and the configuration of the working fluid circuit is generally a function of programmed control of fluid flow valves. These other components are not shown for the sake of clarity and so as not to obscure that which is claimed below within the present discussion.

Although such control systems are readily known to those in the art, one such control system 600 by which the configuration of the working fluid circuit may be controlled is shown in FIG. 6 for the sake of completeness. The control system 600 may include a plurality of fluid flow valves 605 and a controller 610 sending control signals over electrical lines 615. A controller such as the controller 610 may send control signals to the fluid flow valves 605 to control the working fluid flow as described above.

The controller 610 includes a processor-based resource 620 that may be, for example and without limitation, a microcontroller, a microprocessor, an Application Specific Integrated Circuit (“ASIC”), an Electrically Erasable Programmable Read-Only Memory (“EEPROM”), or the like. Depending on the implementation of the processor-based resource, the controller 610 may also include a memory 625 encoded with instructions (not shown) executable by the processor-based resource 620 to implement the functionality of the controller 610. Again, depending on the implementation of the processor-based resource 620, the memory 625 may be a part of the processor-based resource 620 or a stand-alone device. For example, the instructions may be firmware stored in the memory portion of a microprocessor or they may be a routine stored in a stand-alone read-only or random-access memory chip. Similarly, in some implementations of the processor-based resource 620—e.g., an ASIC—the memory 635 may be omitted altogether.

The hybrid LTR disclosed above makes the low temperature thermal medium available for the charging cycle at the “cold discharged” temperature of the generating cycle (T_{c,h}). This has dual benefits for thermodynamic performance and control over the resource state—as typically realized by a fixed-volume, closed-system LTR. The hybrid approach captures these benefits along with benefits typically realized by an open-system LTR. First, it reduces the equipment set and (potentially) the footprint requirements, since all of the low-grade heat rejection is achieved in the LTX and the water tank is not required to store all low temperature thermal medium. Second, it eliminates LTR mass and temperature range constraints.

In a first embodiment, a hybrid low temperature thermal reservoir for use in a Pumped Thermal Energy Storage (“PTES”) system, comprises an open-volume, low temperature, thermal reservoir, a fixed-volume, low temperature, thermal reservoir, and a low temperature thermal medium. In a generating cycle, the low temperature thermal medium is drawn from the fixed-volume low temperature thermal reservoir and the open-volume low temperature thermal reservoir or a combination of the open-volume low temperature thermal reservoir and the fixed-volume low-temperature thermal reservoir and, after receiving rejected heat, is returned to the open-volume low temperature thermal reservoir, or the fixed-volume low temperature thermal reservoir, or a combination thereof. In a charging cycle, the low temperature thermal medium is drawn from one of the fixed-volume low temperature thermal reservoir and the open-volume low temperature thermal reservoir and, after giving heat, returns to the open-volume low temperature thermal reservoir, or the fixed-volume low temperature thermal reservoir, or a combination thereof.

In a second embodiment, in the hybrid low temperature thermal reservoir of the first embodiment, in the generating cycle, after the low temperature thermal medium receives the reject heat, at least a portion of the low temperature thermal medium is returned to one of the open-volume low temperature thermal reservoir or the fixed-volume low temperature thermal reservoir.

In a third embodiment, in the hybrid low temperature thermal reservoir of the first embodiment, the open-volume low temperature thermal reservoir is an environmental system.

In a fourth embodiment, in the hybrid low temperature thermal reservoir of the first embodiment, the fixed-volume low temperature thermal reservoir is an engineered tank.

In a fifth embodiment, in the hybrid low temperature thermal reservoir of the first embodiment, the low temperature medium is water.

In a sixth embodiment, in the hybrid low temperature thermal reservoir of the first embodiment, in the generating cycle, the rejected heat includes excess heat is heat introduced by system non-idealities.

In a seventh embodiment, in the hybrid low temperature thermal reservoir of the first embodiment, returning the low temperature thermal medium in the generating cycle includes returning a portion of the low temperature medium to the open-volume low temperature thermal reservoir or to the fixed-volume low temperature thermal reservoir and the rest of the low temperature medium to the fixed-volume low temperature thermal reservoir.

In an eighth embodiment, a Pumped Thermal Energy Storage (“PTES”) system comprises a high temperature thermal reservoir, a hybrid low temperature thermal reservoir, and a working fluid circuit through which a working fluid circulates. The hybrid low temperature thermal reservoir includes an open-volume, low temperature, thermal reservoir and a fixed-volume, low temperature, thermal reservoir. In a charging cycle, heat is rejected from the working fluid to the high temperature thermal reservoir and received from the hybrid low temperature thermal reservoir to the working fluid. In a generating cycle, heat is received from the high temperature thermal reservoir to the working fluid and heat is rejected from the working fluid to the hybrid low temperature thermal reservoir.

In a ninth embodiment, in the PTES system of the eighth embodiment, the working fluid circuit further includes a high temperature heat exchanger, and a low temperature heat exchanger. In the high temperature heat exchanger, heat is rejected from the working fluid to the high temperature thermal reservoir in the charging cycle, and heat is received from the working fluid to the high temperature thermal reservoir in the generating cycle. In the low temperature heat exchanger, heat is received from the hybrid low temperature thermal reservoir to the working fluid in the charging cycle and heat is rejected to the hybrid low temperature thermal reservoir from the working fluid in the generating cycle. In the charging cycle, an expansion device positioned between an output from the high temperature heat exchanger and an input to low temperature heat exchanger and a compression device positioned between an output of the low temperature heat exchanger and an input to the high temperature heat exchanger. In the generating cycle, a pump positioned between an output of the low temperature heat exchanger and an input to the high temperature heat exchanger; and a turbine positioned between an output of the high temperature heat exchanger and an input to the low temperature exchanger.

In a tenth embodiment, in the PTES system of the eighth embodiment, the hybrid low temperature thermal reservoir further includes a low temperature medium that: in the generating cycle, the low temperature medium is drawn from the open-volume low temperature thermal reservoir or a combination of the open-volume low temperature thermal reservoir and the fixed-volume low-temperature thermal reservoir and, after receiving rejected heat, is returned to the open-volume low temperature thermal reservoir, or the fixed-volume low temperature thermal reservoir, or a combination thereof; and in the charging cycle, the low temperature medium is drawn from either the fixed-volume low temperature thermal reservoir or the open-volume low temperature thermal reservoir and, after giving heat, returns to the open-volume low temperature thermal reservoir, or the fixed-volume low temperature thermal reservoir, or a combination thereof.

In an eleventh embodiment, in the PTES system of the tenth embodiment, in the generating cycle, after the low temperature thermal medium receives the reject heat, at least a portion of the low temperature thermal medium is returned to one of the open-volume low temperature thermal reservoir or the fixed-volume low temperature thermal reservoir.

In a twelfth embodiment, in the PTES system of the tenth embodiment, the fixed-volume low temperature thermal reservoir is an engineered tank.

In a thirteenth embodiment, in the PTES system of the tenth embodiment, the excess heat is heat introduced by system non-idealities.

In a fourteenth embodiment, in the PTES system of the tenth embodiment, returning the excess heat includes returning a portion of the low temperature medium to the open-volume low temperature thermal reservoir or to the fixed-volume reservoir.

In a fifteenth embodiment, a method for use in operating a Pumped Thermal Energy Storage (“PTES”) system comprises: operating the PTES system in a charging cycle and in a generating cycle. In the generating cycle, a low temperature thermal medium is from a fixed-volume low temperature thermal reservoir, an open-volume low temperature thermal reservoir, or a combination thereof of a hybrid low temperature thermal reservoir and, after receiving rejected heat, returns excess heat to the open-volume low temperature thermal reservoir or to the fixed-volume low temperature thermal reservoir or a combination thereof and the non-excess heat to the fixed volume reservoir. In the charging cycle, the low temperature thermal medium is drawn from a fixed-volume, low temperature, thermal reservoir of the hybrid low temperature thermal reservoir and, after giving heat, returning the low temperature thermal medium to the open-volume, low temperature, thermal reservoir.

In a sixteenth embodiment, in the method of the fifteenth embodiment, in the generating cycle, after the low temperature thermal medium receives the reject heat, at least a portion of the low temperature thermal medium is returned to one of the open-volume low temperature thermal reservoir or the fixed-volume low temperature thermal reservoir.

In a seventeenth embodiment, in the method of the fifteenth embodiment, the open-volume low temperature thermal reservoir is an environmental system.

In an eighteenth embodiment, in the method of the fifteenth embodiment, the fixed-volume low temperature thermal reservoir is an engineered tank.

In a nineteenth embodiment, in the method of the fifteenth embodiment, the excess heat is heat introduced by system non-idealities.

In a twentieth, in the method of the fifteenth embodiment, returning the excess heat includes returning a portion of the low temperature medium to the open-volume low temperature thermal reservoir or to the fixed-volume reservoir.

The nomenclature used throughout this disclosure uses the terms “high temperature” and “low temperature”. These terms are used to identify certain processes, actions, and components of the PTES system. These terms “high temperature” and “low temperature” are defined relative to one another as is usual and customary in the art. Thus, for example, heat exchange occurs at a “lower” temperature in the “low temperature” heat exchanger than they do in the “high temperature” heat exchanger. For another example, the temperature of the “high temperature” thermal medium is “higher” than is the temperature of the “low temperature” thermal medium. Thus, the identification of the “high temperature” thermal reservoir and the “low temperature” thermal reservoir indicates the relative temperatures of the thermal media stored therein.

The quantification of “high temperature” and “low temperature” and the difference therebetween will depend on a number of factors well known and understood by those skilled in the art. Factors may include, for example, the design and implementation of the working fluid circuit. Other factors may be implicated. The hybrid low temperature thermal reservoir includes an open-volume, low temperature, thermal reservoir. In some embodiments, the open-system, low temperature, thermal reservoir is implemented in an environmental system. In such embodiments, factors influencing the quantification of “low temperature” may include environmental factors such as ambient temperature and pressure. Those in the art having the benefit of this disclosure will be able to recognize and apply these factors to arrive at implementation specific quantifications in light of their particular working fluid circuit design and implementation.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A hybrid low temperature thermal reservoir for use in a Pumped Thermal Energy Storage (“PTES”) system, comprising:
an open-volume low temperature thermal reservoir;
a fixed-volume low temperature thermal reservoir; and
a low temperature medium that:
in a generating cycle, is drawn from the fixed-volume low temperature thermal reservoir and the open-volume low temperature thermal reservoir or a combination of the open-volume low temperature thermal reservoir and the fixed-volume low-temperature thermal reservoir and, after receiving rejected heat, is returned to the open-volume low temperature thermal reservoir, or the fixed-volume low temperature thermal reservoir, or a combination thereof; and
in a charging cycle, is drawn from one of the fixed-volume low temperature thermal reservoir and the open-volume low temperature thermal reservoir and, after giving heat, returns to the open-volume low temperature thermal reservoir, or the fixed-volume low temperature thermal reservoir, or a combination thereof.

2. The hybrid low temperature thermal reservoir of claim 1, wherein, in the generating cycle, after the low temperature thermal medium receives the reject heat, at least a portion of the low temperature thermal medium is returned to one of the open-volume low temperature thermal reservoir or the fixed-volume low temperature thermal reservoir.

3. The hybrid low temperature thermal reservoir of claim 1, wherein the open-volume low temperature thermal reservoir is an environmental system.

4. The hybrid low temperature thermal reservoir of claim 1, wherein the fixed-volume low temperature thermal reservoir is an engineered tank.

5. The hybrid low temperature thermal reservoir of claim 1, wherein the low temperature medium is water.

6. The hybrid low temperature thermal reservoir of claim 1, wherein, in the generating cycle, the rejected heat includes excess heat is heat introduced by system non-idealities.

7. The hybrid low temperature thermal reservoir of claim 1, wherein returning the low temperature thermal medium in the generating cycle includes returning a portion of the low temperature medium to the open-volume low temperature thermal reservoir or to the fixed-volume low temperature thermal reservoir and the rest of the low temperature medium to the fixed-volume low temperature thermal reservoir.

8. A Pumped Thermal Energy Storage (“PTES”) system, comprising:
a high temperature thermal reservoir;
a hybrid low temperature thermal reservoir including:
an open-volume low temperature thermal reservoir; and
a fixed-volume low temperature thermal reservoir;
a working fluid circuit through which a working fluid circulates, and in which:
in a charging cycle, heat is rejected from the working fluid to the high temperature thermal reservoir and received from the hybrid low temperature thermal reservoir to the working fluid; and
in a generating cycle, heat is received from the high temperature thermal reservoir to the working fluid and heat is rejected from the working fluid to the hybrid low temperature thermal reservoir.

9. The PTES system of claim 8, wherein the working fluid circuit, further includes:
a high temperature heat exchanger in which:
heat is rejected from the working fluid to the high temperature thermal reservoir in the charging cycle; and
heat is received from the working fluid to the high temperature thermal reservoir in the generating cycle;
a low temperature heat exchanger in which:
heat is received from the hybrid low temperature thermal reservoir to the working fluid in the charging cycle; and
heat is rejected to the hybrid low temperature thermal reservoir from the working fluid in the generating cycle;
in the charging cycle:
an expansion device positioned between an output from the high temperature heat exchanger and an input to low temperature heat exchanger; and
a compression device positioned between an output of the low temperature heat exchanger and an input to the high temperature heat exchanger; and
in the generating cycle:
a pump positioned between an output of the low temperature heat exchanger and an input to the high temperature heat exchanger; and
a turbine positioned between an output of the high temperature heat exchanger and an input to the low temperature exchanger.

10. The PTES system of claim 8, wherein the hybrid low temperature thermal reservoir further includes a low temperature medium that:
in the generating cycle, the low temperature medium is drawn from the open-volume low temperature thermal reservoir or a combination of the open-volume low temperature thermal reservoir and the fixed-volume low-temperature thermal reservoir and, after receiving rejected heat, is returned to the open-volume low temperature thermal reservoir, or the fixed-volume low temperature thermal reservoir, or a combination thereof; and
in the charging cycle, the low temperature medium is drawn from either the fixed-volume low temperature thermal reservoir or the open-volume low temperature thermal reservoir and, after giving heat, returns to the open-volume low temperature thermal reservoir, or the fixed-volume low temperature thermal reservoir, or a combination thereof.

11. The PTES system of claim 10, wherein, in the generating cycle, after the low temperature thermal medium receives the reject heat, at least a portion of the low temperature thermal medium is returned to one of the open-volume low temperature thermal reservoir or the fixed-volume low temperature thermal reservoir.

12. The PTES system of claim 10, wherein the fixed-volume low temperature thermal reservoir is an engineered tank.

13. The PTES system of claim 10, wherein, in the generating cycle, the rejected heat includes excess heat is heat introduced by system non-idealities.

14. The PTES system of claim 10, wherein returning the low temperature thermal medium in the generating cycle includes returning a portion of the low temperature medium to the open-volume low temperature thermal reservoir or to the fixed-volume low temperature thermal reservoir and the rest of the low temperature medium to the fixed-volume low temperature thermal reservoir.

15. A method for use in operating a Pumped Thermal Energy Storage (“PTES”) system, the method comprising:
operating the PTES system in a charging cycle and in a generating cycle; and
in a generating cycle, drawing a low temperature medium from a fixed-volume low temperature thermal reservoir, an open-volume low temperature thermal reservoir, or a combination thereof of a hybrid low temperature thermal reservoir and, after receiving rejected heat, returns excess heat to the open-volume low temperature thermal reservoir or to the fixed-volume low temperature thermal reservoir, or a combination thereof and the non-excess heat to the fixed volume reservoir; and
in a charging cycle, drawing a low temperature medium from a fixed-volume low temperature thermal reservoir of the hybrid low temperature thermal reservoir and, after giving heat, returning the low temperature medium to the open-volume low temperature thermal reservoir.

16. The method of claim 15, wherein, in the generating cycle, after the low temperature thermal medium receives the reject heat, at least a portion of the low temperature thermal medium is returned to one of the open-volume low temperature thermal reservoir or the fixed-volume low temperature thermal reservoir.

17. The method of claim 15, wherein the open-volume low temperature thermal reservoir is an environmental system.

18. The method of claim 15, wherein the fixed-volume low temperature thermal reservoir is an engineered tank.

19. The method of claim 15, wherein, in the generating cycle, the rejected heat includes excess heat is heat introduced by system non-idealities.

20. The method of claim 15, wherein returning the low temperature thermal medium in the generating cycle includes returning a portion of the low temperature medium to the open-volume low temperature thermal reservoir or to the fixed-volume low temperature thermal reservoir and the rest of the low temperature medium to the fixed-volume low temperature thermal reservoir.
